(19) United States
(12) Patent Application Publication
(10) Pub. No.: US 2024/0220150 A1
(43) Pub. Date: Jul. 4, 2024

(54) COMPUTATIONAL STORAGE DEVICES, STORAGE SYSTEMS INCLUDING THE SAME, AND OPERATING METHODS THEREOF

(71) Applicant: Samsung Electronics Co., Ltd., Suwon-si (KR)

(72) Inventors: Heeseok Eun, Suwon-si (KR); Seunghan Lee, Suwon-si (KR); Jinwook Lee, Suwon-si (KR); Soo-Young Ji, Suwon-si (KR)

(21) Appl. No.: 18/341,164

(22) Filed: Jun. 26, 2023

(30) Foreign Application Priority Data
Jan. 4, 2023 (KR) 10-2023-0001246

(51) Int. Cl. G06F 3/06

(52) U.S. Cl. CPC G06F 3/0655; G06F 3/0604; G06F 3/0679

(57) ABSTRACT

In a storage system, a first computational storage device may be configured to store first data used to execute a program, and a second computational storage device may be configured to store second data used to execute the program. The second computational storage device may be configured to receive the program offloaded from the host device, bring the first data from the first computational storage device, and execute the program using a plurality of data including the first data and the second data.

### CROSS-REFERENCE TO RELATED APPLICATION

This application claims priority to and the benefit of Korean Patent Application No. 10-2023-0001246 filed in the Korean Intellectual Property Office on Jan. 4, 2023, and the entire contents of the above-identified application are incorporated herein by reference.

### BACKGROUND

### (a) Field

The disclosure relates to computational storage devices, storage systems including the same, and operating methods thereof.

### (b) Description of the Related Art

In recent years, in order to reduce a computational burden on a host, computational storage devices have been developed that can execute various computational operations or various applications within a storage device. Such a computational storage device may provide computation and data storage, allowing the host to store data in the computational storage device and offload execution of one or more applications to the computational storage device. The computational storage device can execute the application offloaded thereto using the data that is stored by the computational storage device.

On the other hand, if multiple computational storage devices are connected to the host, the application that is offloaded and executed on a first computational storage device may need to use data stored in ones of the multiple computational storage devices other than the first computational storage device. This data may not be available to the first computational storage device.

### SUMMARY

Some embodiments may provide computational storage devices, storage systems including the same, and operating methods thereof, in which data distributed and stored in a plurality of computational storage devices may be used.

According to some embodiments, a storage system may include a plurality of computational storage devices and a host device configured to offload a program to one or more computational storage devices among the plurality of computational storage devices. The plurality of computational storage devices may include a first computational storage device and a second computational storage device. The first computational storage device may store first data used to execute the program. The second computational storage device may store second data that are used to execute the program, receive the offloaded program from the host device, bring the first data from the first computational storage device into the second computational storage device, and execute the program using a plurality of data including the first data brought into the second computational storage device and the second data.

According to some embodiments, a computational storage device may include a non-volatile memory device, a local memory, and a compute engine. The non-volatile memory device may store first data used in execution of a first program offloaded from a host device. The local memory may store the first data transferred from the non-volatile memory device, and store second data used in execution of the first program and transferred from other computational storage device. The compute engine may execute the first program offloaded from the host device using a plurality of data including the first data and the second data.

According to some embodiments, a method of operating a storage system including a plurality of computational storage devices and a host device, and the plurality of computational storage devices may include a first computational storage device and a second computational storage device. The method may include offloading a program from the host device to the first computational storage device, transferring first data from a first non-volatile memory device of the first computational storage device to a local memory of the first computational storage device in response to a first command from the host device, transferring second data from a second non-volatile memory device of the second computational storage device to a shared memory space of the second computational storage device in response to a second command from the host device, transferring the second data from the shared memory space to the local memory of the first computational storage device, and executing the program on the first computational storage device using a plurality of data including the first data and the second data.

### BRIEF DESCRIPTION OF THE DRAWINGS

FIG. 1 is a block diagram illustrating an example of a storage system according to some embodiments.

FIG. 2 is a block diagram illustrating an example of a computational storage device according to some embodiments.

FIG. 3 is a diagram illustrating an example of program offloading in a storage system according to some embodiments.

FIG. 4 is a diagram illustrating an example of program execution in a storage system according to some embodiments.

FIG. 5 is a diagram illustrating an example of an operating method of a storage system according to some embodiments.

FIG. 6. FIG. 7, and FIG. 8 each are a flowchart illustrating an example of an operating method of a storage system according to some embodiments.

FIG. 9, FIG. 10, and FIG. 11 each are a diagram illustrating an example of a method of selecting a computational storage device in a storage system according to some embodiments.

### DETAILED DESCRIPTION OF THE EMBODIMENTS

In the following detailed description, only some embodiments of the present inventive concepts have been shown and described, simply by way of illustration. As those skilled in the art would realize, the described embodiments may be modified in various different ways, all without departing from the spirit or scope of the present inventive concepts.

Accordingly, the drawings and description are to be regarded as illustrative in nature and not restrictive. Like reference numerals designate like elements throughout the specification. Any sequence of operations or steps provided herein is not limited to the order presented in the claims or figures unless specifically indicated otherwise. The order of operations or steps may be changed, several operations or steps may be merged, a certain operation or step may be divided, and/or a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

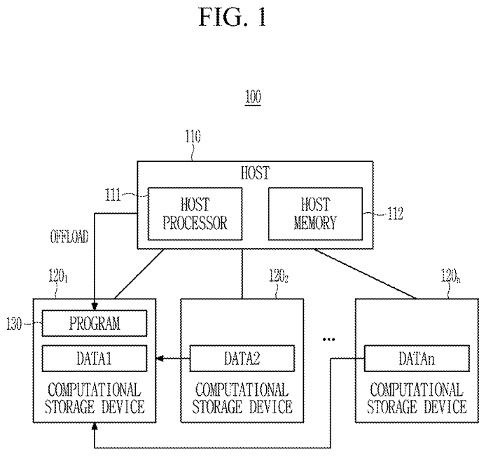

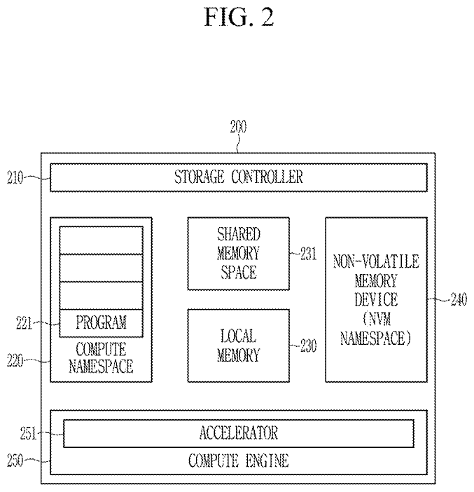

FIG. 1 is a block diagram illustrating an example of a storage system according to some embodiments, and FIG. 2 is a block diagram illustrating an example of a computational storage device according to some embodiments.

Referring to FIG. 1, a storage system 100 may include a host device 110 and a plurality of computational storage devices 1201, 1202 . . . 120n. In some embodiments, the storage system 100 may be a computing device.

The host device 110 may include a host processor 111 and a host memory 112. The host processor 111 may control an overall operation of the host device 110. The host processor 111 may be implemented as at least one of various processing units, including, for example, a central processing unit (CPU), an application processor (AP), a graphic processing unit (GPU), a neural processing unit (NPU), a field-programmable gate array (FPGA), and/or a microprocessor. In some embodiments, the host processor 111 may be implemented as a system-on-a-chip (SoC). The host memory 112 may store data, instructions, and programs required for operations of the host processor 111. The host memory 112 may be, for example, a dynamic random-access memory (DRAM).

The computational storage devices 1201 to 120n may be semiconductor devices (e.g., storage devices) that provide computational services and data storage services. The computational storage devices 1201 to 120n may be used as both data storage in the storage system 100 and computational devices to execute an offloaded program. In some embodiments, the computational storage devices 1201 to 120n may be, for example, data center or artificial intelligence training data devices.

In some embodiments, the host device 110 may control operations of the computational storage devices 1201 to 120n via a computer express link (CXL) interface. The CXL interface may include CXL.io, CXL.cache, and CXL.mem as subprotocols.

The host device 110 may offload a program 130 to one or more computational storage devices (e.g., 1201) from among the plurality of computational storage devices 1201 to 120n. The host device 110 may offload various types of programs 130, such as an application, a kernel, and/or a computation, to the computational storage device 1201. The program 130 may include, for example, an encryption program, a compression program, an image recognition program, a filtering program, and/or an artificial intelligence program.

When data DATA1, DATA2 . . . DATAn required for execution of the program 130 are distributedly stored in the plurality of computational storage devices 1201 to 120n, the computational storage device 1201 may bring the distributed data DATA2 to DATAn from the other computational storage devices 1202 to 120n. The computational storage device 1201 may execute the program 130 using the data DATA1 that it stores and the data DATA2 to DATAn obtained from the other computational storage devices 1202 to 120n.

Referring to FIG. 2, in some embodiments, a computational storage device 200 may include a storage controller 210, a local memory 230, a non-volatile memory device 240, and a compute engine 250. The computational storage device 200 may correspond to one of computational storage devices 1201 to 120, shown in FIG. 1.

The storage controller 210 may store data in the non-volatile memory device 240 and/or read data stored in the non-volatile memory device 240 in response to an input/output (I/O) request from a host device (e.g., the host device 110 in FIG. 1). In some embodiments, the computational storage device 200 may use a non-volatile memory express (NVMe) protocol as a storage protocol, and the storage controller 210 may be an NVMe controller 210.

In some embodiments, the storage controller 210 may perform various operations to control the non-volatile memory device 240. The various operations may include, for example, an address mapping operation, a wear-leveling operation, and/or a garbage collection operation. The address mapping operation may be a translation operation between a logical address managed by the host device 110 and a physical address of the non-volatile memory device 240. The wear-leveling operation may be an operation that equalizes the frequency or number of uses of a plurality of memory blocks included in the non-volatile memory device 240. The garbage collection operation may an operation that copies valid data from a source block of the non-volatile memory device 240 to a target block, and then erases the source block, thereby securing available blocks or free blocks in the non-volatile memory device 240.

The compute engine 250 may execute a program 221 that is offloaded from the host device 110. In some embodiments, the program 221 may be stored in a program slot. The program slot may be formed in the compute engine 250, or may be allocated in a separate memory. In some embodiments, the program slot in which the program 221 is stored may be within or may form a compute namespace 220, which is an entity that is able to execute the program 221. The compute namespace 220 may be, for example, an entity in an NVMe subsystem. The compute namespace 220 may access the local memory 230. In some embodiments, the computational storage device 200 may include one or more compute namespaces 220. If the computational storage device 200 includes a plurality of compute namespaces 220, the host device 110 may offload a plurality of programs respectively to the plurality of compute namespaces 220 (e.g., in a one-to-one relationship). Thus, each offloaded program 221 may be managed in a respective compute namespace 220, with the understanding that the present disclosure is not limited thereto.

The compute engine 250 may include a hardware accelerator 251. In some embodiments, the accelerator 251 may be implemented as at least one of various processing units including a GPU, a digital signal processing unit (DSP), a NPU, and/or a coprocessor. In some embodiments, the accelerator 251 may copy data stored in the non-volatile memory device 240 to the local memory 230 and/or a shared memory space 231, and/or may copy data stored in the local memory 230 and/or the shared memory space 231 to the non-volatile memory device 240.

The local memory 230 may be a memory accessed and used by the compute engine 250, which may store data to be used by the offloaded program 221 or store a result from execution of the program 221. In some embodiments, the local memory 230 may also be accessed by the storage controller 210. In some embodiments, the local memory 230 may be a local memory in the NVMe subsystem, which may be referred to as a subsystem local memory (SLM). The computational storage device 200 may further include the shared memory space 231 that may be accessed by other computational storage devices. The data stored in the shared memory space 231 may be transferred to the local memory 230 of another computational storage device 200. In some embodiments, the local memory 230 and the shared memory space 231 may be provided as separate memory devices. In some other embodiments, the shared memory space 231 may be provided as a memory space within the local memory 230. In this case, the host device 110 may designate a space within the memory device that is accessible by other computational storage devices as the shared memory space 231. For example, the host device 110 may designate a space that supports the CXL.mem and/or CXL.cache protocols of the CXL protocol and set the space to the shared memory space 231. The local memory 230 and the shared memory space 231 may be implemented as, for example, a DRAM.

In some embodiments, the storage controller 210 and/or the compute engine 250 may further include a memory controller (not shown) that controls the local memory 230 and/or the shared memory space 231. In some embodiments, the memory controller may be provided as a separate chip from the storage controller 210 and/or the accelerator 251. In some other embodiments, the memory controller may be provided as an internal component of the storage controller 210 and/or the accelerator 251.

The non-volatile memory device 240 may store data of the storage system 100. The non-volatile memory device 240 may include, for example, a flash memory such as a NAND flash memory. In another example, the non-volatile memory device 240 may include, for example, a phase-change memory, a resistive memory, a magnetoresistive memory, a ferroelectric memory, or a polymer memory. The non-volatile memory device 240 may form a non-volatile memory (NVM) namespace. In some embodiments, the computational storage device 200 may further include a memory controller (e.g., a flash memory controller) that controls or is configured to control the non-volatile memory device 240, and the non-volatile memory device 240 and the flash memory controller may form the NVM namespace.

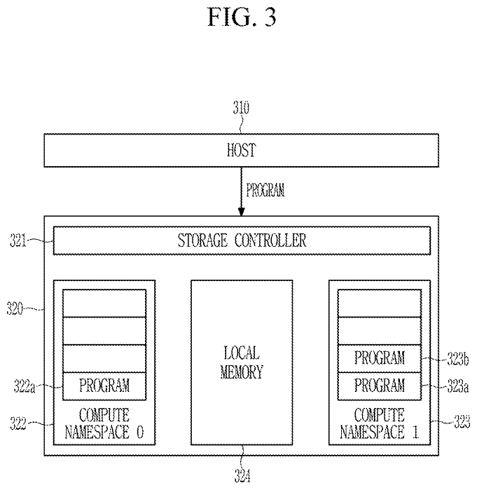

FIG. 3 is a diagram illustrating an example of program offloading in a storage system according to some embodiments.

Referring to FIG. 3, a host device 310 may offload a program to a computational storage device 320. In FIG. 3, the computational storage device 320 is shown to include two compute namespaces 322 and 323, but the number of compute namespaces 322 and 323 is not limited thereto.

In some embodiments, the compute namespaces 322 and 323 may support device-defined programs and/or downloadable programs. A device-defined program may be, for example, a fixed program provided by a manufacturer, and a downloadable program may be a program that is loaded into the computational storage devices 322 and 323 by or from the host device 310. For example, the device-defined program 323a may be provided in the compute namespace 323.

For example, the host device 310 may identify the compute namespace 322 as/dev/nvme0n0 and the compute namespace 323 as/dev/nvme0n1. Accordingly, the host device 310 may offload a program 322a to be executed in the compute namespace 322 to/dev/nvme0n0 and a program 323b to be executed in the compute namespace 323 to/dev/nvme0n1. In some embodiments, a storage controller 321 of the computational storage device 320 may receive the programs 322a and 323b transferred from the host device 310 and store them in the computational storage device 320.

Compute engines (e.g., 250 in FIG. 2) may execute the programs 322a, 323a, and 323b in the compute namespaces 322 and 323 using data stored in the local memory 324 in response to a program execution command from the host device 310.

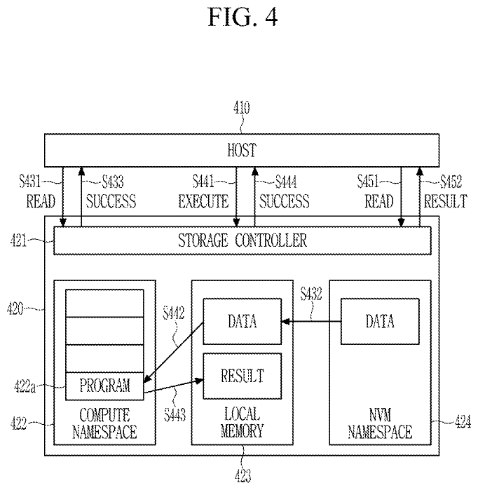

FIG. 4 is a diagram illustrating an example of program execution in a storage system according to some embodiments. In FIG. 4, it is assumed that a program 422a is offloaded to a compute namespace 422 of a computational storage device 420.

Referring to FIG. 4, a host device 410 may send a data read command to a storage controller 421 of the computational storage device 420 in operation S431. In response to the data read command, data stored in a non-volatile memory device (e.g., NVM namespace) 424 may be copied to a local memory 423 in operation S432. In some embodiments, the storage controller 421 may control the NVM namespace 424 and the local memory 423 in response to the data read command to transfer the data from the NVM namespace 424 to the local memory 423. In some embodiments, the storage controller 421 may send the data read command to a compute engine (e.g., compute engine 250 in FIG. 2), and the compute engine 250 may control the NVM namespace 424 and the local memory 423 in response to the data read command to transfer the data from NVM namespace 424 to the local memory 423. For example, under a control of the storage controller 421 or the compute engine 250, a flash memory controller may read the data from NVM namespace 424 and store the data in the local memory 423.

After copying the data from the NVM namespace 424 to the local memory 423 is complete, the storage controller 421 may send a read success message to the host device 410 in operation S433.

To execute the program, the host device 410 may send a command to the computational storage device 420 to execute the program 422a in the compute namespace 422 in operation S441. In some embodiments, the storage controller 421 may receive the program execution command from the host device 410 and may send the program execution command to the compute engine 250. In response to the program execution command, the compute engine 250 may execute the program 422a in the compute namespace 422 using the data stored in the local memory 423 in operation S442. The compute engine 250 may store an execution result of the program 422a in the local memory 423 in operation S443. After the execution of the program 422a in the compute namespace 422 is complete, the storage controller 421 may send a message indicating successful execution of the program to the host device 410 in operation S444.

In some embodiments, the host device 410 may send to the computational storage device 420 a read command of instructing to read data from the local memory 423 in operation S451. The storage controller 421 may read the data from the local memory 423 (e.g., the execution result of the program 422a) and transfer it to the host device 410 in operation S452.

The storage system may execute the program on the computational storage device 420 by performing the above-described operations. Further, if requested by the host device 410, the storage system may provide the result execution of the program from the computational storage device 420 to the host device 410.

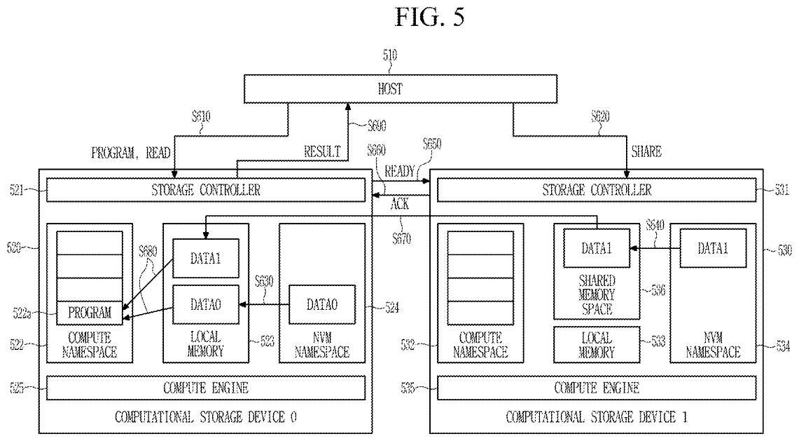

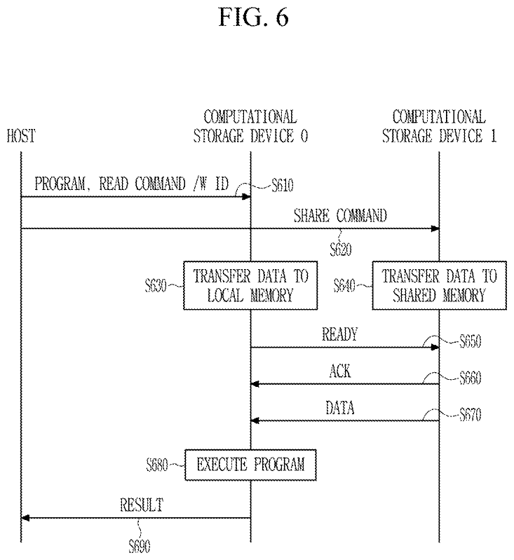

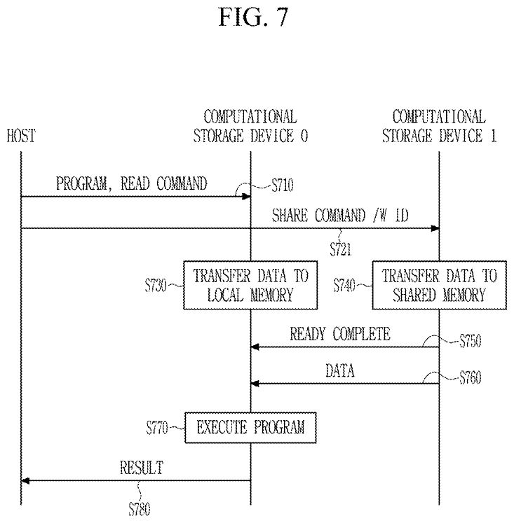

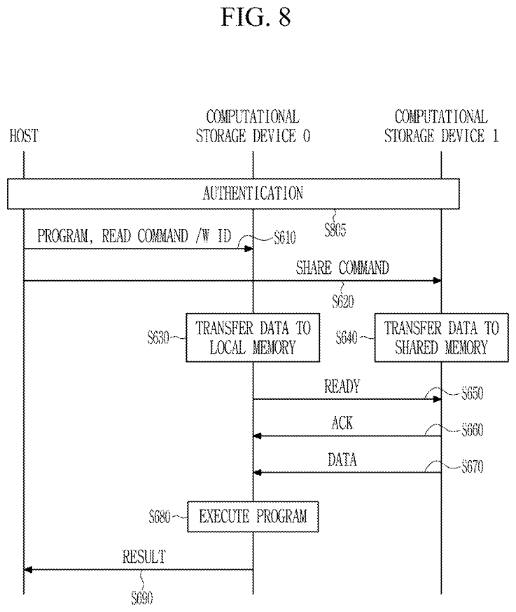

FIG. 5 is a diagram illustrating an example of an operating method of a storage system according to some embodiments, and FIG. 6, FIG. 7, and FIG. 8 each are a flowchart illustrating an example of an operating method of a storage system according to some embodiments.

Referring to FIG. 5, a storage system may include a host device 510 and a plurality of computational storage devices 520 and 530. Data used to execute a program 522a to be offloaded from the host device 510 may be distributedly stored in the computational storage devices 520 and 530 (e.g., a first part of the data may be stored in the computational storage device 520, and a second part of the data may be stored in the computational storage device 530). Although a case where the data are distributedly stored in the two computational storage devices 520 and 530 is shown for convenience in FIG. 5, the number of computational storage devices in which the data are distributedly stored is not limited thereto.

The computational storage device 520 may include a storage controller 521, a compute namespace 522, a local memory 523, an NVM namespace 524, and a compute engine 525. The computational storage device 530 may also include a storage controller 531, a compute namespace 532, a local memory 533, an NVM namespace 534, and a compute engine 535. The computational storage device 530 may further include a shared memory space 536. In some embodiments, the host device 510 may set the shared memory space 536 in the computational storage device 530 (e.g., the local memory 533).

Some data DATA0 of the data used to execute the program 522a may be stored in the NVM namespace 524 of the computational storage device 520, and some other data DATA1 of the data used to execute program 522a may be stored in the NVM namespace 534 of the computational storage device 530. For example, the program 522a may be an image recognition program, and the data that are a subject of image recognition may be distributedly stored in the computational storage devices 520 and 530. In this case, if the computational storage device 520 executes the image recognition program 522a using only its own stored data DATA0, an incomplete image recognition result may be obtained. Accordingly, the storage system according to some embodiments may transfer the data stored in the computational storage device 530 to the computational storage device 520.

Referring to FIGS. 5 and 6, the host device 510 may select a computational storage device (e.g., 520) to which the program 522a is to be offloaded from among the computational storage devices 520 and 530, and may offload (transfer) the program 522a to the selected computational storage device 520 in operation S610. In some embodiments, when the host device 510 offloads the program 522a to the computational storage device 520, the host device 510 may send a data read command to the computational storage device 520 in operation S610. For example, the host device 510 may transfer the data read command to the computational storage device 520 along with the program 522a. In another example, the host device 510 may send the data read command to the computational storage device 520 after offloading the program 522a to the computational storage device 520.

Additionally, the host device 510 may send a data share command to the other computational storage devices 530 where the data are distributed in operation S620. In some embodiments, the host device 510 may set a shared memory space 536 in the computational storage device 530 and send the data share command to the computational storage device 530. In some embodiments, the data share command may include location information (e.g., an address range) of the shared memory space 536 to which the data are to be transferred.

In some embodiments, when transferring the program 522a or the data read command from the host device 510 to the computational storage device 520 in operation S610, the host device 510 may provide the computational storage device 520 with identification information of the other computational storage device 530 in which the data are distributedly stored. For example, the data read command or a command indicating to offload the program may include the identification information of the other computational storage device 530. Accordingly, the computational storage device 520 may identify the other computational storage device 530 where the data are distributedly stored (e.g., the computational storage device 530 to which a ready message is to be sent in operation S650).

The computational storage device 520 may transfer (e.g., copy) some data DATA0 stored in the non-volatile memory device (e.g., NVM namespace) 524 to the local memory 523 in response to the data read command in operation S630. In some embodiments, the storage controller 521 of the computational storage device 520 may receive the data read command, and the NVM namespace 524 may transfer the data DATA1 to the local memory 523 under a control of the storage controller 521. In some other embodiments, the storage controller 521 of the computational storage device 520 may receive the data read command and send it to the compute engine 525, and the NVM namespace 524 may transfer the data DATA1 to the local memory 523 under a control of the compute engine 525. For example, under the control of storage controller 521 or compute engine 525, a flash controller in the NVM namespace 524 may read the data DATA0 from the non-volatile memory device and transfer the data DATA0 to the local memory 523.

Additionally, the computational storage device 530 may transfer (e.g., copy) some data DATA1 stored in the non-volatile memory device (e.g., NVM namespace) 534 to the shared memory space 536 in response to the data share command in operation S640. In some embodiments, the storage controller 531 of the computational storage device 530 may receive the data share command, and the NVM namespace 534 may transfer the data DATA1 to the shared memory space 536 under a control of the storage controller 531. In some other embodiments, the storage controller 531 of the computational storage device 530 may receive the data share command and send it to the compute engine 535, and the NVM namespace 534 may transfer the data DATA1 to the shared memory space 536 under a control of the compute engine 535. For example, under the control of storage controller 531 or compute engine 535, a flash controller in the NVM namespace 534 may read the data DATA1 from the non-volatile memory device and transfer the data DATA1 to the shared memory space 536.

Next, the computational storage device 520 may send to the computational storage device 530 a ready message of querying whether the data DATA1 are ready in the shared memory space 536 in operation S650. In some embodiments, the storage controller 521 of the computational storage device 520 may send the ready message to the storage controller 531 of the computational storage device 530. In some other embodiments, the compute engine 525 of the computational storage device 520 may send the ready message to the compute engine 535 of the computational storage device 530.

If the transfer of data DATA1 from the NVM namespace 534 to the shared memory space 536 has been complete, the computational storage device 530 may send to the computational storage device 520 an acknowledgment (ACK) message indicating completion of the transfer of the data DATA1 in response to the ready message in operation S660. In some embodiments, the storage controller 531 of the computational storage device 530 may send the ACK message to the storage controller 521 of the computational storage device 520. In some other embodiments, the compute engine 535 of the computational storage device 530 may send the ACK message to the compute engine 525 of the computational storage device 520. If the transfer of the DATA1 from NVM namespace 534 to the shared memory space 536 is not complete, the computational storage device 530 may send a negative acknowledgment (NACK) message to the computational storage device 520. In some embodiments, the storage controller 531 of the computational storage device 530 may send the NACK message to the storage controller 521 of the computational storage device 520. In some other embodiments, the compute engine 535 of the computational storage device 530 may send the NACK message to the compute engine 525 of the computational storage device 520. Upon receiving the NACK message, the computational storage device 520 may send the ready message to the computational storage device 530 again after a predetermined time has clasped.

In response to the ACK message, the computational storage device 520 may access the shared memory space 536 of the computational storage device 530 to bring the data DATA1 from the shared memory space 536 of the computational storage device 530 into the local memory 523 of the computational storage device 520 in operation S670. In some embodiments, the computational storage device 520, for example, the storage controller 521 or the compute engine 525, may access the shared memory space 536 of the computational storage device 530 and read the data DATA1 from the shared memory space 536 without intervention of the host device 510. In some embodiments, the computational storage device 520 may access the shared memory space 536 using a CXL protocol. The CXL protocol may include, for example, a direct peer-to-peer access protocol defined in a CXL standard (e.g., CXL specification 3.0). In some embodiments, for direct data transfer from the shared memory space 536 to the local memory 523, the computational storage devices 520 and 530 each may include a direct memory access (DMA) engine.

After bringing the data DATA1 from the shared memory space 536 into the local memory 523, the compute engine 525 of the computational storage device 520 may execute the program 522a on the compute namespace 522 using the data DATA0 and DATA1 stored in the local memory 523, and store an execution result of the program 522a in the local memory 523 in operation S680. In some embodiments, the host device 510 may send a program execution command (e.g., S441 in FIG. 4) to the storage controller 521 of the computational storage device 520, and the compute engine 525 may execute the program 522a in response to the program execution command transferred from the storage controller 521. In some embodiments, after the compute engine 525 completes executing the program 522a, the storage controller 521 may send a message (e.g., S444 in FIG. 4) indicating successful program execution to the host device 510.

The computational storage device 520 may provide the execution result of the program 522a from the local memory 523 to the host device 510 in operation S690. In some embodiments, the host device 510 may send to the storage controller 521 of the computational storage device 520 a read command (e.g., S451 in FIG. 4) of instructing the storage controller 521 to read data from the local memory 523. In response to the read command, the storage controller 521 may read the execution result of the program 522a from the local memory 523 and provide the execution result to the host device 510.

As described above, when the data DATA0 and DATA1 are distributedly stored in the plurality of computational storage devices 520 and 530, the computational storage device 520 for executing the program 522a may bring the data of the other computational storage device 530 into the computational storage device 520, thereby executing the program 522a.

Referring to FIGS. 5 and 7, in some embodiments, unlike embodiments described with reference to FIG. 6, the computational storage device 520 may not send to the computational storage device 530 the ready message of inquiring whether the data DATA1 are ready in the shared memory space 536. Detailed descriptions of operations similar to the operations described with reference to FIG. 6 are omitted.

A host device 510 may offload a program 522a to a computational storage device 520 and send a data read command to the computational storage device 520 in operation S710. The host device 510 may also send a data share command to the other computational storage device 530 where data are distributed in operation S720. In some embodiments, when sending the data share command to the computational storage device 530 in operation S720, the host device 510 may provide the computational storage device 530 with identification information of the computational storage device 520 to which the program is offloaded. For example, the data share command may include the identification information of the computational storage device 520. Accordingly, the computational storage device 530 may identify the computational storage device 520 on which the program 522a is to be executed.

The computational storage device 520 may transfer (e.g., copy) some data DATA0 stored in a non-volatile memory device (e.g., NVM namespace) 524 to a local memory 523 in response to the data read command in operation S730. Further, the computational storage device 530 may transfer (e.g., copy) some data DATA1 stored in a non-volatile memory device (e.g., NVM namespace) 534 to a shared memory space 536 in response to the data share command in operation S740.

If the data DATA1 are ready in the shared memory space 536, the computational storage device 530 may send to the computational storage device 530 a ready message indicating that the data DATA1 are ready in operation S750. In response to the ready message, the computational storage device 520 may access the shared memory space 536 of the computational storage device 530 to bring the data DATA1 from the shared memory space 536 of the computational storage device 530 into the local memory 523 of the computational storage device 520 in operation S770.

After bringing the data DATA1 from the shared memory space 536 into the local memory 523, the compute engine 525 of the computational storage device 520 may execute the program 522a on the compute namespace 522 using the data DATA0 and DATA1 stored in the local memory 523, and may store an execution result of the program 522a in the local memory 523 in operation S780. The computational storage device 520 may provide the execution result of the program 522a from the local memory 523 to the host device 510 in operation S790.

Referring to FIGS. 5 and 8, in some embodiments, the host device 510 may perform authentication on the computational storage devices 520 and 530 in operation S805 before sharing data distributed between the computational storage devices 520 and 530. After performing the authentication, the storage system may perform operations S610 to S690 described with reference to FIG. 6 or operations S710 to S790 described with reference to FIG. 7. In this way, by performing the authentication on the computational storage devices 520 and 530, the computational storage device 520 may access the computational storage device 530 while maintaining security.

In some embodiments, the host device 510 may send an authentication request message to the computational storage device 520 and authenticate the computational storage device 520 based on a response message from the computational storage device 520. Similarly, the host device 510 may send an authentication request message to the computational storage device 530 and authenticate the computational storage device 530 based on a response message from the computational storage device 530. That is, the host device 510 may authenticate cach of the plurality of computational storage devices 520 and 530.

In some other embodiments, the host device 510 may send an authentication initiate message to one or more computational storage devices among the plurality of computational storage devices 520 and 530. Then, a computational storage device 520 receiving the authentication initiate message may send an authentication request message to the other computational storage device 530 and perform authentication based on a response message from the computational storage device 530. For example, the host device 510 may send the authentication initiate message to the computational storage device 520 to which the program is to be offloaded, and the computational storage device 520 may act as a master or primary computational storage device and authenticate the other computational storage devices 530, which may act as secondary computational storage devices 530.

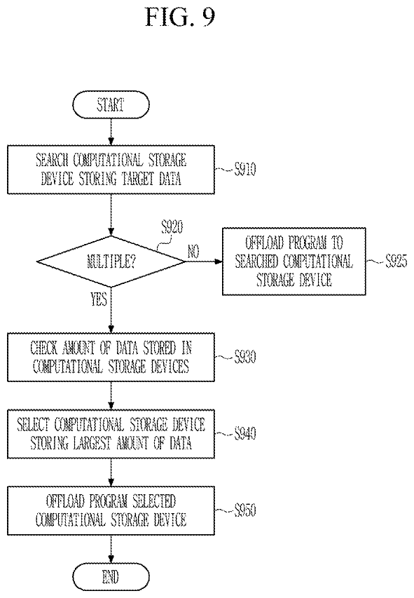

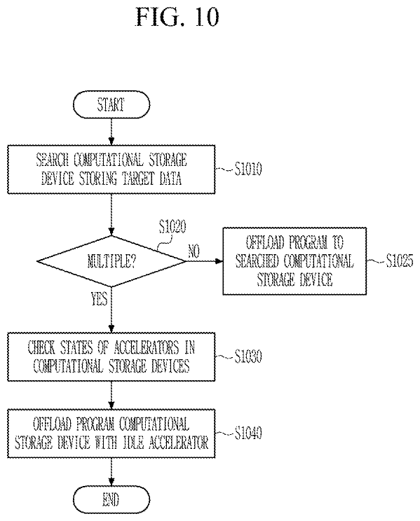

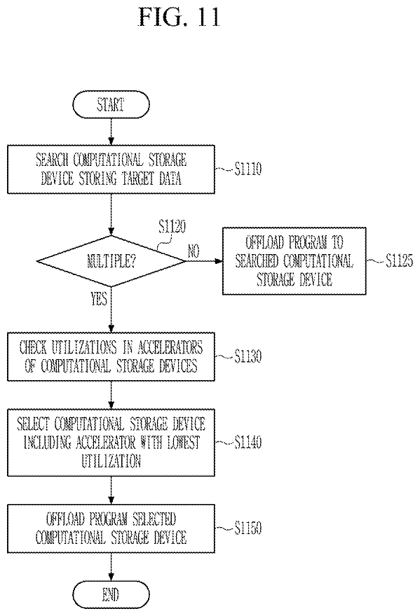

Next, a method of selecting a computational storage device to which a program is to be offloaded in a storage system according to various embodiments is described with reference to FIG. 9 to FIG. 11.

FIG. 9 is a diagram illustrating an example of a method of selecting a computational storage device in a storage system according to some embodiments.

Referring to FIG. 9, before offloading a program to be executed on a computational storage device, a host device (e.g., a host processor of the host device) may search for a computational storage device in which data (referred to as “target data”) used to execute the program are stored in operation S910. In some embodiments, the host device may search for the computational storage device where the target data are stored based on a storage history of the target data or address information of a location where the target data are stored. If one computational storage device is detected as the computational storage device storing the target data in operation S920, the host device may offload the program to the detected computational storage device in operation S925.

On the other hand, a plurality of computational storage devices may be detected as the computational storage device storing target data in operation S920. In this case, each of the plurality of computational storage devices may store a part of the target data. Accordingly, the host device may determine an amount of target data stored in each of the plurality of computational storage devices in operation S930. The host device may select the computational storage device having the largest amount of stored target data among the plurality of computational storage devices as the computational storage device to which the program is to be offloaded in operation S940, and may offload the program to the selected computational storage device in operation S950.

As described above, offloading the program to the computational storage device having the largest amount of target data may minimize data movement between the plurality of computational storage devices.

FIG. 10 is a diagram illustrating an example of a method of selecting computational storage device in a storage system according to some embodiments.

Referring to FIG. 10, before offloading a program to be executed on a computational storage device, a host device may search for a computational storage device that stores target data used to execute the program in operation S1010. If one computational storage device is detected as the computational storage device storing the target data in operation S1020, the host device may offload the program to the detected computational storage device in operation S1025.

On the other hand, if a plurality of computational storage devices are detected as the computational storage device storing the target data in operation S1020, the host device may check a state of an accelerator in each of the plurality of computational storage devices in operation S1030. The host device may offload the program to a computational storage device including an accelerator that is in an idle state among the plurality of computational storage devices in operation S1030. In some embodiments, the host device may manage the states of the accelerators in the plurality of computational storage devices and identify the idle accelerator based on the managed states of the accelerators. In some other embodiments, the host device may query each of the plurality of computational storage devices for the state of the accelerator, and receive the state of the accelerator from each of the plurality of computational storage devices.

As described above, by offloading the program to the computational storage device having the idle accelerator, the program may be executed efficiently.

FIG. 11 is a diagram illustrating an example of a method of selecting a computational storage device in a storage system according to some embodiments.

Referring to FIG. 11, before offloading a program to be executed on a computational storage device, a host device may search for a computational storage device that stores target data used to execute the program in operation S1110. If one computational storage device is detected as the computational storage device storing the target data in operation S1120, the host may offload the program to the detected computational storage device in operation S1125.

On the other hand, if a plurality of computational storage devices are detected as the computational storage device storing the target data in operation S1120, the host device may determine a utilization of an accelerator in each of the plurality of computational storage devices in operation S1130. In some embodiments, the host device may manage a state of the accelerator in each of the plurality of computational storage devices, and may determine the utilizations of the accelerators based on the states of the managed accelerators. In some embodiments, the host device may query each of the plurality of computational storage devices for the utilization of the accelerator, and may receive the utilization of the accelerator from each of the plurality of computational storage devices.

The host device may select the computational storage device including the accelerator with the lowest utilization among the plurality of computational storage devices as the computational storage device to which the program is to be offloaded in operation S1140, and may offload the program to the selected computational storage device in operation S1150.

As described above, by offloading the program to the computational storage device including the accelerator with the lowest utilization, the program may be executed efficiently.

While the inventive concepts disclosed herein have been described in connection with what is presently considered to be practical embodiments, it is to be understood that the inventive concepts are not limited to the disclosed embodiments. On the contrary, the present disclosure is intended to cover various modifications and equivalent arrangements included within the scope of the appended claims.

What is claimed is:

1. A storage system comprising:
a plurality of computational storage devices; and
a host device configured to offload a program to one or more computational storage devices among the plurality of computational storage devices,
wherein the plurality of computational storage devices comprises:
a first computational storage device configured to store first data used to execute the program; and
a second computational storage device configured to:
store second data used to execute the program,
receive the offloaded program from the host device,
bring the first data from the first computational storage device into the second computational storage device, and
execute the program using a plurality of data comprising the first data brought into the second computational storage device and the second data.

2. The storage system of claim 1, wherein the first computational storage device comprises:
a first non-volatile memory device configured to store the first data;
a memory space configured to store the first data transferred from the first non-volatile memory device; and
a first compute engine,
wherein the second computational storage device comprises:
a second non-volatile memory device configured to store the second data;
a local memory configured to store the second data transferred from the second non-volatile memory device, and configured to store the first data brought from the memory space; and
a second compute engine configured to execute the program using the plurality of data comprising the first data and the second data stored in the local memory.

3. The storage system of claim 2, wherein the first compute engine and the second compute engine each comprise an accelerator.

4. The storage system of claim 2, wherein the memory space is a space accessible by the second computational storage device without intervention of the host device.

5. The storage system of claim 4, wherein the second computational storage device is configured to access the memory space based on a computer express link (CXL) protocol.

6. The storage system of claim 2, wherein the first computational storage device further comprises a second local memory, and
wherein the host device is further configured to set the memory space in the second local memory.

7. The storage system of claim 2, wherein the host device is further configured to send a first command to the first computational storage device, and send a second command to the second computational storage device,
wherein the first computational storage device further comprises a first storage controller configured to receive the first command and transfer the first data from the first non-volatile memory device to the memory space in response to the first command, and
wherein the second computational storage device further comprises a second storage controller configured to receive the second command and transfer the second data from the second non-volatile memory device to the local memory in response to the second command.

8. The storage system of claim 7, wherein the second computational storage device is further configured to send to the first computational storage device a first message querying whether the first data are ready in the memory space,
wherein the first computational storage device is further configured to, when transfer of the first data to the memory space is complete, send a second message to the second computational storage device in response to the first message, the second message indicating that the first data are ready in the memory space,
wherein the second computational storage device is further configured to bring the first data from the memory space into the local memory in response to the second message.

9. The storage system of claim 7, wherein the first computational storage device is further configured to send a message to the second computational storage device when transfer of the first data to the memory space is complete, and
wherein the second computational storage device is further configured to bring the first data from the memory space into the local memory in response to the message.

10. The storage system of claim 1, wherein the host device is further configured to select, as the second computational storage device, a computational storage device that stores a greatest amount of data used for execution of the program from among the plurality of computational storage devices.

11. The storage system of claim 1, wherein each of the plurality of computational storage devices comprises an accelerator, and
wherein the host device is further configured to select, as the second computational storage device, a computational storage device comprising the accelerator having an idle state from among the plurality of computational storage devices.

12. The storage system of claim 1, wherein each of the plurality of computational storage devices comprises an accelerator, and
wherein the host device is further configured to select, as the second computational storage device, a computational storage device comprising the accelerator having a lowest utilization from among the plurality of computational storage devices.

13. The storage system of claim 1, wherein the host device is further configured to perform authentication on the first computational storage device and the second computational storage device.

14. The storage system of claim 1, wherein the first computational storage device and the second computational storage device are further configured to perform authentication between the first computational storage device and the second computational storage device.

15. A computational storage device comprising:
a non-volatile memory device configured to store first data used in execution of a first program offloaded from a host device;
a local memory configured to store the first data transferred from the non-volatile memory device, and store second data that are used in execution of the first program and transferred from other computational storage device; and
a compute engine configured to execute the first program offloaded from the host device using a plurality of data comprising the first data and the second data.

16. The computational storage device of claim 15, further comprising a storage controller configured to transfer the first data from the non-volatile memory device to the local memory, and bring the second data from a shared memory space of the other computational storage device into the local memory.

17. The computational storage device of claim 15, wherein the compute engine is further configured to transfer the first data from the non-volatile memory device to the local memory, and configured to bring the second data stored in a shared memory space of the other computational storage device into the local memory.

18. The computational storage device of claim 15, further comprising a shared memory space configured to be accessible by the other computational storage device,
wherein the non-volatile memory device is further configured to store third data used by a second program to be executed on the other computational storage device, and
wherein the shared memory space is further configured to store the third data transferred from the non-volatile memory device.

19. A method of operating a storage system comprising a plurality of computational storage devices and a host device, the plurality of computational storage devices comprising a first computational storage device and a second computational storage device, the method comprising:
offloading a program from the host device to the first computational storage device;
transferring first data from a first non-volatile memory device of the first computational storage device to a local memory of the first computational storage device in response to a first command from the host device;
transferring second data from a second non-volatile memory device of the second computational storage device to a shared memory space of the second computational storage device in response to a second command from the host device;
transferring the second data from the shared memory space to the local memory of the first computational storage device; and
executing the program using a plurality of data comprising the first data and the second data on the first computational storage device.

20. The method of claim 19, further comprising notifying from the second computational storage device to the first computational storage device that transfer of the second data device to the shared memory space is complete.
